(19) United States
(12) Patent Application Publication
(10) Pub. No.: US 2012/0162227 A1
(43) Pub. Date: Jun. 28, 2012

(54) Method of Picture Display and Device Thereof

(76) Inventors: Li-Po Chou, New Taipei City (TW); Ming-Fong Yeh, New Taipei City (TW); Yu-Chi Chang, New Taipei City (TW)

(21) Appl. No.: 13/070,463

(22) Filed: Mar. 23, 2011

(30) Foreign Application Priority Data
Dec. 24, 2010 (TW) 099145749

(51) Int. Cl. G06T 3/40

(52) U.S. Cl. 345/428

(57) ABSTRACT

A method of displaying a picture for an electronic device with picture display function includes determining whether a resolution of a picture inputted into the electronic device is greater than a resolution of a display device of the electronic device, displaying the picture in the display device when the resolution of the picture is smaller or equivalent to the resolution of the display device, and reducing the resolution of the picture and then displaying the reduced picture in the display device when the resolution of the picture is greater than the resolution of the display device.

### BACKGROUND OF THE INVENTION

1. Field of the Invention

The present invention relates to a method of picture display and device thereof, and more particularly, to a method of picture display and device thereof capable of displaying high-resolution pictures swiftly.

2. Description of the Prior Art

Due to limited memories and retrenched processors, embedded products, such as multimedia players, TVs, mobile phones, etc., are unable to behave as well as PCs or laptops. When playing a high-resolution picture, the embedded products are bound to have problems of poor playback of the picture or system failure due to insufficient memories.

A conventional picture display method is briefed as follows. Please refer to FIG. 1, which is a schematic diagram of a conventional electronic device 10 having a display function. The electronic device 10 can be any embedded product, e.g. a multimedia player, TV or mobile phone, which includes a processor 100, a random access memory 102, a display memory 104, a display unit 106 and a display device 108. When the processor 100 receives a picture file 110, such as a joint photographic experts group (JPEG) format image, the processor 100 retrieves an extraction command from the random access memory 102 and performs an extraction operation on the picture file 110. After the extraction operation completes, the processor 100 saves the extracted picture data to the display memory 104, and the display unit 106 outputs the picture data in display memory 104 to the display device 108.

In short, the electronic device 10 saves row data of the picture in the display memory 104 upon receiving the picture. Take a 4096×4096 image for example, each pixel is 4 bytes, which requires 4096×4096×4=64 MB of memories. A larger image requires even more memories. When employing a PC or laptop for picture display, no issue would arise with sufficient memories. However, under an embedded environment with limited memories, poor playback of the picture or the picture cannot be played at all is often the case.

### SUMMARY OF THE INVENTION

It is therefore a primary objective of the present invention to provide a method of picture display and device thereof to avoid poor playback of pictures, so as to enhance display performance.

The present invention discloses a picture display method for an electronic device having a display function. The method includes determining whether a resolution of an inputted picture of the electronic device is greater than a resolution of a display device of the electronic device, and scaling down the resolution of the picture, and displaying the downscale picture via display device when the resolution of the picture is greater than the resolution of the display device.

The present invention further discloses an electronic device, for displaying an inputted picture thereof. The electronic device includes a memory for store a program codes of a process, a processor, coupled to the memory, for processing the program codes to execute the process, wherein the process includes determining whether a resolution of the inputted picture of the electronic device is greater than a resolution of a display device of the electronic device, and scaling down the resolution of the picture, and displaying the downscale picture via display device when the resolution of the picture is greater than the resolution of the display device.

The present invention further discloses a picture processor for processing an inputted picture of an electronic device having a display function. The picture processor includes a display detection unit for acquiring width pixel numbers and height pixel numbers of a display device of the electronic device, a picture reading unit for reading data of the picture, a picture detection unit for acquiring width pixel numbers and height pixel numbers of the picture, and a picture scaling-down unit for calculating a desired downscale ratio for the width pixel numbers and height pixel numbers of the picture, and performing a scale-down operation to the data of the picture read by the picture reading unit, to scale down the picture to conform to the downscale ratio, according to the width pixel numbers and height pixel numbers of the display device and the picture acquired by the display detection unit and the picture detection unit respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional electronic device having a display function.

FIG. 2 is a flowchart of a process according to an embodiment of the present invention.

FIG. 3 is a schematic diagram of a scale-down operation performed on a picture according to an embodiment of the present invention.

FIG. 4 is a schematic diagram of a picture processor according to an embodiment of the present invention.

### DETAILED DESCRIPTION

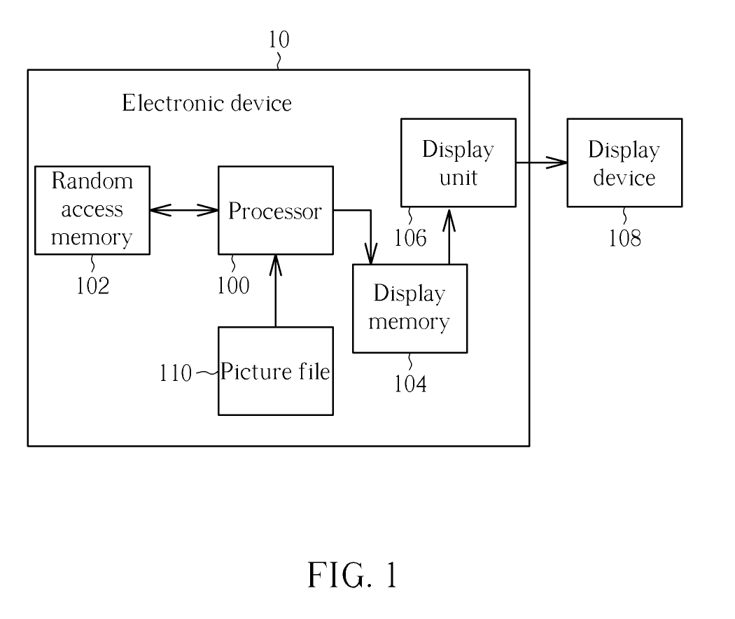

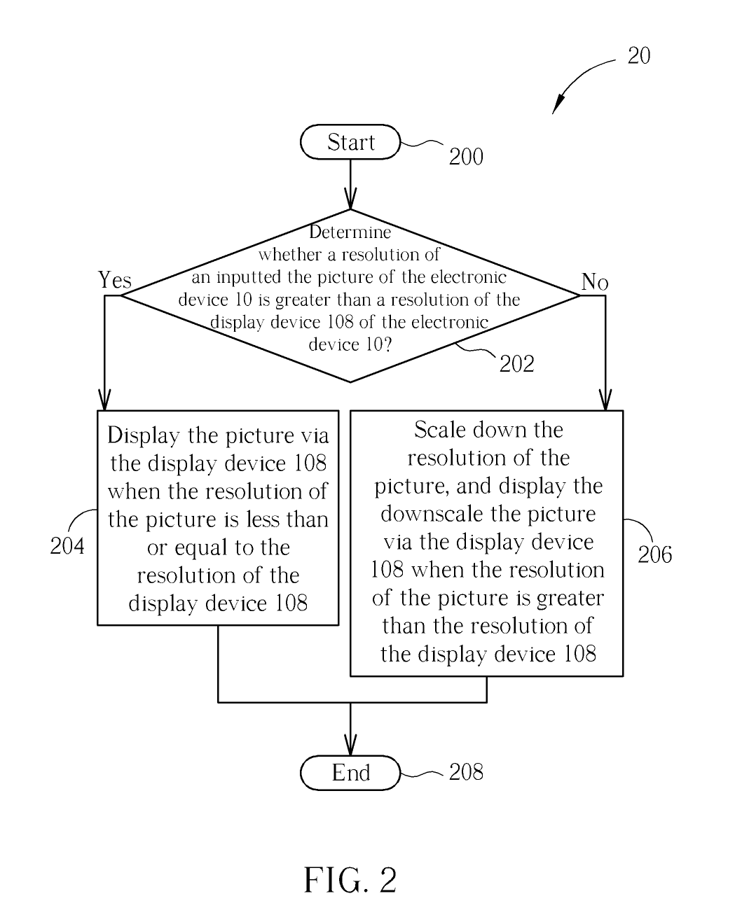

Please refer to FIG. 2, which is a schematic diagram of a process 20 according to an embodiment of the present invention. The process 20 is utilized for the electronic device 10 as shown in FIG. 1, such as a multimedia player, liquid crystal display (LCD) TV, mobile phone, etc. The process 20 includes the following steps:

Step 200: Start.

Step 202: Determine whether a resolution of an inputted the picture of the electronic device 10 is greater than a resolution of the display device 108 of the electronic device 10.

Step 204: Display the picture via the display device 108 when the resolution of the picture is less than or equal to the resolution of the display device 108.

Step 206: Scale down the resolution of the picture, and display the downscale the picture via the display device 108 when the resolution of the picture is greater than the resolution of the display device 108.

Step 208: End.

According to the process 20, after the picture is inputted into the electronic device 10, the electronic device 10 determines whether the resolution of the picture is greater than the resolution of the display device 108. If the resolution of the picture is less than or equal to the resolution of the display device 108, the electronic device 10 directly displays the picture on the display device 108. On the contrary, if the resolution of the picture is greater than the resolution of the display device 108, the electronic device 10 scales down the resolution of the picture, and then displays the downscale picture on the display device 108. With the process 20, when the resolution of the picture is greater than the resolution of the display device 108, the resolution of the picture is scaled down to reduce memory for storing the picture. Thus, the process 20 avoids lagging or delaying of the picture display caused by insufficient memories, so as to display high-resolution pictures swiftly, hence elevating display performance.

More specifically, when the resolution of the picture is less than or equal to the resolution of the display device 108, the processor 100 of the electronic device 10 reads the data of the picture, and saves all the read data of the picture in the display memory 104 of the electronic device 10, and the display unit 106 outputs the data of the picture in the display memory 104 to the display device 108. On the other hand, when the resolution of the picture is greater than the resolution of the display device 108, the processor 100 calculates a desired downscale ratio of the picture according to the resolution of the picture and the resolution of the display device 108, then reads the data of the picture, and performs a scale-down operation (can be stored in the random access memory 102) on the read data of the picture, to scale down the picture to conform to the calculated downscale ratio, and finally, saves the downscale data of the picture in the display memory 104, and outputs the data of the picture in the display memory 104 to the display device 108 via display unit 106.

In addition, the scale-down operation is detailed as follows. The processor 100 calculates a desired downscale ratio of height pixels and width pixels of the picture according to height pixel numbers and width pixel numbers of the picture and the display device 108 respectively, so as to scale down the picture to conform to the downscale ratio. Next, the processor 100 calculates minimum requisite memories of the scale-down operation according to the scale-down operation, reads the data of the picture in units of the minimum requisite memories sequentially, and performs the scale-down operation to one unit of the read data at a time, and the scale-down operation of all the units are completed until all the data of the picture are read. In short, when the original picture is greater than the maximum resolution of the display device 108, the processor 100 reads the data of the picture and scales down the read data to conform to the resolution of the display device 108 side by side, prior to saving in memory. Thus, the maximum requisite memories only have to satisfy the maximum resolution of the display device 108. Take a high-definition (HD) display device with 1920×1080 pixels for example, the requisite memories are merely 1920×1080×4=8 MB, which avoids defects of poor playback of the picture display caused by insufficient memory.

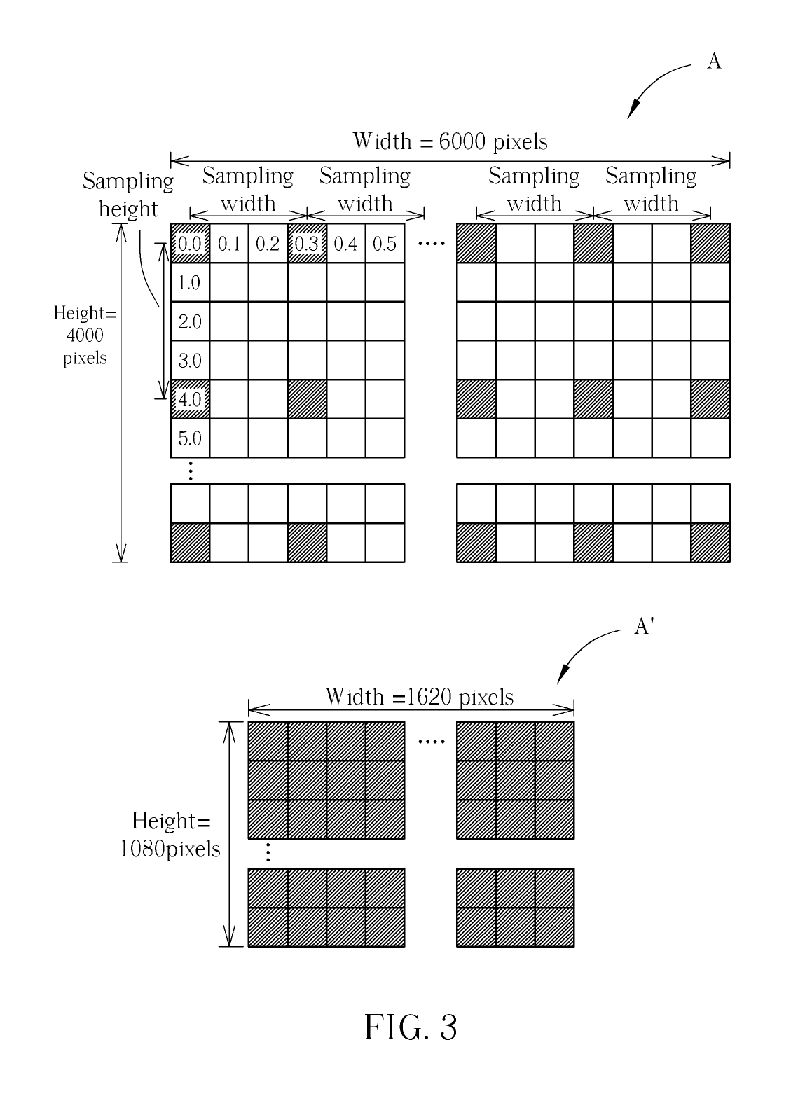

Please refer to FIG. 3, which is a schematic diagram of a scale-down operation performed on a picture according to an embodiment of the present invention. In the embodiment, the scale-down operation is performed by a sampling method. As shown in FIG. 3, a sampling width of the picture is 3 pixels, while a sampling height is 4 pixels, i.e. the processor 100 extracts pixels according to the sampling width and sampling height of the picture, e.g. 1 pixel for every 3 pixels regarding to the width of the picture, and 1 pixel for every 4 pixels regarding to the height of the picture, upon reading the picture in units of requisite memories of the scale-down operation. As derived from FIG. 3, a resolution of the original picture A is 6000×4000 pixels, which requires 6000×4000×4 bytes of memories. After performing the scale-down operation by the sampling method, the original picture A is scaled down to a picture A′ with a resolution of 1620×1080 pixels, and the requisite memories thereof are also reduced, so as to hasten playback of high-resolution pictures.

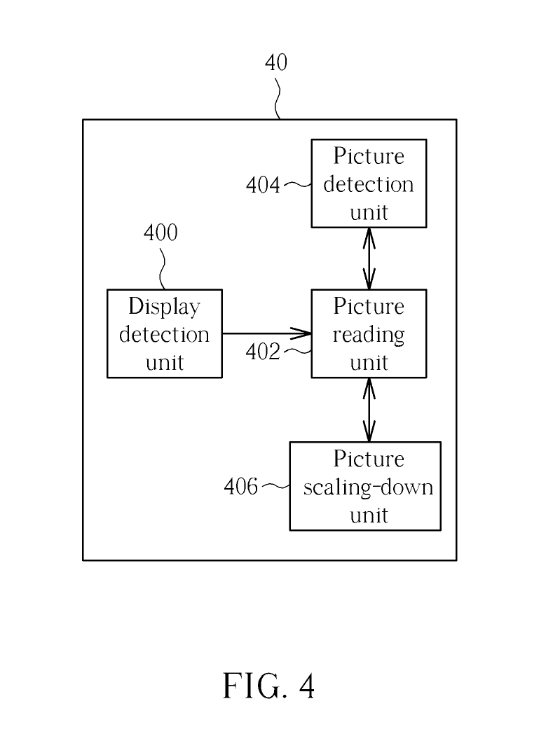

In addition, for those skilled in the art, implementations of the process 20 can to be achieved by software or hardware methods via the processor 100. For example, please refer to FIG. 1. The electronic device 10 includes at least one memory and the processor 100. The memory can be a storage device utilized for storing any data, e.g. the random access memory 102 shown in FIG. 1, and the stored data include program codes compiled according to the process 20, and read and processed by the processor 100 to execute and implement the steps of the process 20. For another example, please refer to FIG. 4, which is a schematic diagram of a picture processor 40 according to an embodiment of the present invention. The picture processor 40 is disposed in the processor 100, including a display detection unit 400, a picture reading unit 402, a picture detection unit 404 and a picture scaling-down unit 406. The display detection unit 400 is utilized for acquiring width pixel numbers and height pixel numbers of the display device 108 of the electronic device 10. The picture reading unit 402 is utilized for reading the data of the inputted picture of the electronic device 10, and the picture detection unit 404 is utilized for acquiring width pixel numbers and height pixel numbers of the picture. The picture scaling-down unit 406 is utilized for calculating a desired downscale ratio of the width pixels and height pixels of the picture according to the width pixel numbers and height pixel numbers of the display device 108 and the picture acquired by the display detection unit 400 and the picture detection unit 404 respectively, and performing a scale-down operation on the data of the picture read by the picture reading unit 402, to scale down the picture to conform to the downscale ratio.

Note that, the process 20 is realized by the picture processor 40 via utilizing the display detection unit 400, the picture reading unit 402 and the picture detection unit 404 to execute the step 202, wherein the picture detection unit 404 acquires the width pixel numbers and height pixel numbers of the picture according to a header of the data of the picture read by the picture reading unit 402, and via using the picture reading unit 402 and the picture scaling-down unit 406 to execute the step 206. Noticeably, the picture scaling-down unit 406 calculates minimum requisite memories of the scale-down operation, and uses the picture reading unit 402 to read the data of the picture in units of the minimum requisite memories, performs the scale-down operation to one unit of the read data at a time, until all the data of the picture are read, and the scale-down operation of all the units are completed, to scale down the picture to conform to the downscale ratio. In addition, the picture scaling-down unit 406 is further utilized for saving the data of the downscale picture in a memory, e.g. the display memory 104 shown in FIG. 1, and the display unit 106 outputs the data of the picture in the memory to the display device 108, to display the downscale picture. Related specifications and modifications can be referred in previous contents, and not narrated herein.

To sum up, the present invention determines whether to scale down a resolution of an inputted picture by determining whether the resolution of the picture is greater than a resolution of a display device. When the resolution of the picture is greater than the resolution of the display device, the present invention properly scales down the resolution of the picture, to avoid defects of unsuccessful playback of picture display due to insufficient memories, so as to heighten efficiency of the picture display.

Those skilled in the art will readily observe that numerous modifications and alterations of the device and method may be made while retaining the teachings of the invention.

What is claimed is:

1. A picture display method, for an electronic device having a display function, the method comprising:
determining whether a resolution of an inputted picture of the electronic device is greater than a resolution of a display device of the electronic device; and
scaling down the resolution of the picture, and displaying the downscale picture via display device when the resolution of the picture is greater than the resolution of the display device.

2. The method of claim 1, wherein the step of scaling down the resolution of the picture, and displaying the downscale picture via display device when the resolution of the picture is greater than the resolution of the display device, comprising:
calculating a desired downscale ratio of the picture according to the resolution of the picture and the resolution of the display device;
reading data of the picture, and performing a scale-down operation to the data of the read picture, to scale down the picture to conform to the downscale ratio;
storing data of the downscale picture in a memory of the electronic device; and
outputting the data in the memory to the display device.

3. The method of claim 2, wherein the step of calculating the desired downscale ratio of the picture according to the resolution of the picture and the resolution of the display device, comprising:
calculating the desired downscale ratio for height pixels and width pixels of the picture according to height pixel numbers and width pixel numbers of the picture and height pixel numbers and width pixel numbers of the display device.

4. The method of claim 2, wherein the step of reading data of the picture, and performing the scale-down operation to the data of the read picture, to scale down the picture to conform to the downscale ratio, comprising:
calculating minimum requisite memories of the scale-down operation according to the scale-down operation;
reading the data of the picture in units of the minimum requisite memories sequentially; and
performing the scale-down operation to one unit of the read data at a time, until all the data of the picture are read, and the scale-down operation of all the units are completed.

5. The method of claim 1, further comprising displaying the picture directly via display device without adjusting the resolution of the picture when the resolution of the picture is less than or equal to the resolution of the display device.

6. The method of claim 5, wherein the step of displaying the picture directly via display device without adjusting the resolution of the picture when the resolution of the picture is less than or equal to the resolution of the display device, comprising:
reading data of the picture;
storing the read data in a memory of the electronic device; and
outputting the data in the memory to the display device.

7. An electronic device, for displaying an inputted picture thereof, the electronic device comprising:
a memory, for store a program codes of a process;
a processor, coupled to the memory, for processing the program codes to execute the process;
wherein the process comprises:
determining whether a resolution of the inputted picture of the electronic device is greater than a resolution of a display device of the electronic device; and
scaling down the resolution of the picture, and displaying the downscale picture via display device when the resolution of the picture is greater than the resolution of the display device.

8. The electronic device of claim 7, the step of scaling down the resolution of the picture, and displaying the downscale picture via display device when the resolution of the picture is greater than the resolution of the display device, comprising:
calculating a desired downscale ratio of the picture according to the resolution of the picture and the resolution of the display device;
reading data of the picture, and performing a scale-down operation to the data of the read picture, to scale down the picture to conform to the downscale ratio;
storing data of the downscale picture in a memory of the electronic device; and
outputting the data in the memory to the display device.

9. The electronic device of claim 8, wherein the step of calculating the desired downscale ratio of the picture according to the resolution of the picture and the resolution of the display device, comprising:
calculating the desired downscale ratio for height pixels and width pixels of the picture according to height pixel numbers and width pixel numbers of the picture and height pixel numbers and width pixel numbers of the display device.

10. The electronic device of claim 8, wherein the step of reading data of the picture, and performing the scale-down operation to the data of the read picture, to scale down the picture to conform to the downscale ratio, comprising:
calculating minimum requisite memories of the scale-down operation according to the scale-down operation;
reading the data of the picture in units of the minimum requisite memories sequentially; and
performing the scale-down operation to one unit of the read data at a time, until all the data of the picture are read, and the scale-down operation of all the units are completed.

11. The electronic device of claim 7, wherein the process further comprises displaying the picture directly via display device without adjusting the resolution of the picture when the resolution of the picture is less than or equal to the resolution of the display device.

12. The electronic device of claim 11, wherein the step of displaying the picture directly via display device without adjusting the resolution of the picture when the resolution of the picture is less than or equal to the resolution of the display device, comprising:
reading data of the picture;
storing the read data in a memory of the electronic device; and
outputting the data in the memory to the display device.

13. A picture processor, for processing an inputted picture of an electronic device having a display function, the picture processor comprising:
a display detection unit, for acquiring width pixel numbers and height pixel numbers of a display device of the electronic device;
a picture reading unit, for reading data of the picture;
a picture detection unit, for acquiring width pixel numbers and height pixel numbers of the picture; and
a picture scaling-down unit, for calculating a desired downscale ratio for the width pixel numbers and height pixel numbers of the picture, and performing a scale-down operation to the data of the picture read by the picture reading unit, to scale down the picture to conform to the downscale ratio, according to the width pixel numbers and height pixel numbers of the display device and the picture acquired by the display detection unit and the picture detection unit respectively.

14. The picture processor of claim 13, wherein the data of the picture comprises a header and compression data; and the picture detection unit acquires the width pixel numbers and height pixel numbers of the picture according to the header of the picture read by the picture reading unit.

15. The picture processor of claim 13, wherein the display device comprises a memory and a display unit; and the picture scaling-down unit is further utilized for storing data of the downscale picture in the memory, and the display unit outputs the data of the picture in the memory to the display device, to display the downscale picture on the display device.

16. The picture processor of claim 13, wherein the picture scaling-down unit is further utilized for calculating minimum requisite memories of the scale-down operation, and using the picture reading unit to read the data of the picture in units of the minimum requisite memories sequentially, and performing the scale-down operation to one unit of the read data at a time, until all the data of the picture are read, and the scale-down operation of all the units are completed, to scale down the picture to conform to the downscale ratio.
